(19) United States
(12) Patent Application Publication
(10) Pub. No.: US 2003/0120932 A1
(43) Pub. Date: Jun. 26, 2003

(54) Synchronizing source and destination systems via parallel hash value determinations

(75) Inventor: Michael A. Epstein, Spring Valley, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/028,382

(22) Filed: Dec. 21, 2001

(51) Int. Cl. H04L 9/00

(52) U.S. Cl. 713/181

(57) ABSTRACT

Multiple hash computations are processed in parallel to effect a synchronization between source and destination hashing processes. A plurality of dynamic hash computation processes operate in parallel, each at a particular phase, or delay, relative to the received sequence of data. If the hash result of one of the processes matches a given hash value that is associated with a sequence of data at the source, the data set at the destination that produced the hash result is assured to correspond to the data set at the source than produced the given hash value.

### BACKGROUND OF THE INVENTION

1. Field of the Invention

This invention relates to the field of security systems, and in particular, to a system that facilitates the computation of hash values for contiguous segments of content material.

2. Description of Related Art

Hashing is commonly used to create a one-way encoding of a plurality of data elements. The one-way encoding is such that it is easy to create a hash value from a particular input value or series of input values, but it is extremely difficult, or virtually impossible, to determine a particular input value or series of input values from the hash value. Hash values are commonly used to ‘bind’ a plurality of data elements. The hash value of a particular plurality of data elements identifies the plurality; if one or more of the data elements are changed, a different hash value will result. In a communications system, a hash value corresponding to a set of transmitted data elements is compared to a computed hash value of a set of received data elements, to verify that the received data elements correspond to the transmitted data elements. In a storage system, a hash value of the data elements written to a storage medium is compared to a computed hash value of data elements alleged to correspond to the written data elements, to verify that the data elements have been read from the original storage medium, or from a valid copy of the data elements written to the storage medium. For ease of reference, the term “source” is used herein to define the original data elements for which a ‘source’ hash value is provided, and the term “destination” is used to define the current data elements for which a ‘destination’ hash value is computed for comparison with the source hash value to determine correspondence between the source and destination data values.

Hashing is specifically designed to detect even the slightest alteration of data. A single bit difference between two sets of data will result in distinguishably different hash values. The sensitivity of a hash value to particular data values can be reduced by “rounding” the data values, or other techniques that effectively provide the same input to the hashing function regardless of minor variations in the particular data values. The sensitivity of a hash value to the choice of particular data values provided to the hashing function, however, cannot be reduced. That is, assuming that the data elements vary in value, if the hash value is based on a set of ten data values, the selection of the first through tenth data elements used to compute the hash value at the destination must coincide with the same data elements at the source. That is, the hashing functions at the source and destination must be synchronous.

It is often difficult to assure that source and destination hashing functions are synchronous. For example, hashing is often used in the encoding of copy-protected content material, such as copyright material on CDs, DVDs, and other media. Variations in the recording process and the playback process, particularly in consumer devices that are designed to allow low-cost manufacture, often preclude a true synchronization between source and destination. Therefore, conventional systems that are designed to compare hash values of source and destination systems that are not assumed to be synchronous are generally configured to dynamically determine a localized synchronization. That is, a hash value is determined using a set of data values at an expected synchronization point at the destination. If the computed destination hash value does not correspond to the source hash value, another destination hash value is computed, at a point offset from the expected synchronization point at the destination. If the new destination hash value does not correspond to the source hash value, a new offset is used, and a new destination hash value is computed. The offset from the expected synchronization point is continually expanded about the expected synchronization point, until either local synchronization is achieved (destination hash=source hash), or until the offset is beyond some reasonable bound about the expected synchronization point, at which point the conclusion is reached that the source and destination elements are different. In this scenario, a “well controlled” destination device is likely to achieve local synchronization quickly, whereas a less-controlled (i.e. less-costly) destination device is likely to exhibit a wide variation in the time required to achieve local synchronization.

### BRIEF SUMMARY OF THE INVENTION

It is an object of this invention to provide an efficient method and system for multiple-hash comparisons. It is a further object of this invention to reduce the variability of the time required to effect a synchronization between source and destination hash values.

These objects and others are achieved by processing multiple hash computations in parallel to effect a synchronization between source and destination hashing processes. A plurality of dynamic hash computation processes operate in parallel, each at a particular phase, or delay, relative to the received sequence of data. If the hash result of one of the processes matches a given hash value that is associated with a sequence of data at the source, the data set at the destination that produced the hash result is assured to correspond to the data set at the source than produced the given hash value.

### BRIEF DESCRIPTION OF THE DRAWINGS

The invention is explained in further detail, and by way of example, with reference to the accompanying drawings wherein:

FIG. 1 illustrates an example block diagram of a parallel hashing system in accordance with this invention.

FIG. 2 illustrates an example flow diagram of a parallel hashing system in accordance with this invention.

Throughout the drawings, the same reference numerals indicate similar or corresponding features or functions.

### DETAILED DESCRIPTION OF THE INVENTION

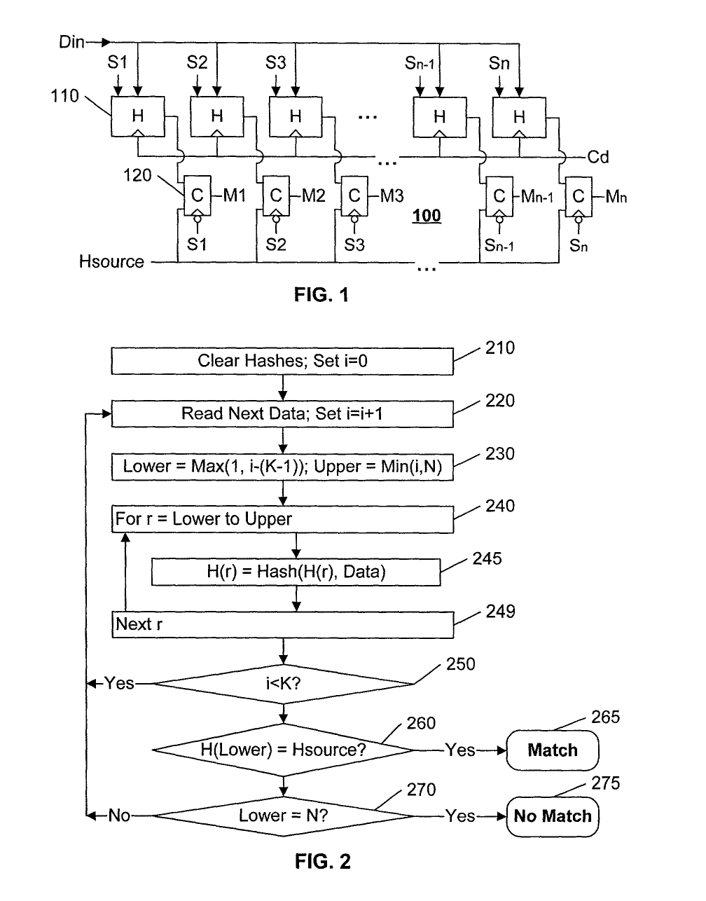

FIG. 1 illustrates an example block diagram of a parallel hashing system 100 in accordance with this invention. The system 100, hereinafter the destination system, receives a sequence of data Din that is purported to be from a source system (not shown). Accompanying this data Din is a hash value Hsource. The hash value Hsource is assumed to be securely communicated from the source system, and corresponds to a hash of a particular segment of data at the source system. If a hash of the received data Din corresponds to the hash value Hsource, this correspondence serves as proof that the received data Din corresponds to data that originated at the source system.

Although the hashing function and the number of data elements used to form the hash value Hsource are known, the particular set of data elements Din corresponding to the hash value Hsource is unknown. As noted above, for example, an encoding of a song on a CD may include one or more hash values corresponding to one or more segments of the encoded song. The hashing function used at the source to produce each hash value is known, including the number of data elements used to produce the hash value, but the determination of the start of each segment at the destination system 100 is subject to some variability. For example, a segment may be defined at the source as being the first k data elements that occur at the ‘beginning’ of each song on a CD. At a destination, such as a playback device, the exact ‘beginning’ of a song may be difficult to determine, at a one-data-element resolution. If the destination device initiates the determination of a hash value at a point in the data stream that differs, even by one data element, from the point in the data stream where the source device initiated the determination of the hash value Hsource, the hash value at the destination will not, generally, correspond to the hash value from the source.

Illustrated in FIG. 1 are “n” hashing devices 110 that are operated in parallel, each of the hashing devices 110 being connected to receive the sequence of data elements Din. Each hashing device 110 is controlled by a corresponding enable signal S1-Sn. When enabled by the corresponding enable signal S1-Sn, each hashing device 110 is configured to execute the same hashing function as the hashing function used to produce the hash value Hsource. The enable signals S1-Sn are asserted for the same number of data samples as used to produce the hash value Hsource, but each commencing at a different time, or phase, relative to the input data Din. The clock signal Cd triggers each hashing device 110 at each new data sample Din in the sequence of data values, and the current data sample Din is applied to each of the enabled hashing devices 110. In a straightforward embodiment, the enable signals S1-Sn are configured to correspond to each sequential data element. For example, S1 starts at a first data element, S2 corresponds to the occurrence of the next data element, S3 to the next data element, and so on. Alternatively, if the destination device 100 receives a trigger or queue that indicates where each hash value commences, such as on particular data word boundaries, the start signals S1-Sn will be configured to commence at each trigger point.

Comparators 120 are configured to compare the determined hash value from each hashing device 110 to the hash value Hsource from the source system. The comparison occurs at the end of each hash value determination, when the corresponding enable signal S1-Sn is de-asserted. If the determined hash value equals the hash value Hsource, a match result M1-Mn is asserted, signaling that the received data Din corresponds to data that originated at the source. Note that individual comparators 120 are illustrated, for ease of understanding. One of ordinary skill in the art will recognize that a single comparator can be used, with appropriate switching circuitry to select the determined hash from each hash device 110 sequentially.

Because the hash determinations and comparisons occur in staggered-parallel fashion, a continuous comparison occurs, and the conventional iterative search for a match is avoided. As illustrated in FIG. 1, a match is reported as soon as it occurs. In a preferred embodiment, the number of parallel circuits, n, is selected to correspond to the expected variance of the synchronization between the source and destination systems. For example, if the expected synchronization point is at time T, and the variance is +/−T1, then n is preferably 2*T1+1. In this embodiment, S1 corresponds to T−T1, S2 corresponds to (T−T1)+1, etc., and Sn corresponds to T+T1. If the number of data values used to compute each hash value, k, is less than n, the number of stages can be reduced, by ‘reusing’ each stage after the comparison is completed. That is, for example, the first stage will complete its comparison at time (T−T1)+(k−1), and will be available to start a new hash determination and comparison with the next data input Din. Thus, the destination system can be configured to contain k hash determination and comparison stages, and the enable signals S1-Sk will be configured to cycle through n data samples, in a round-robin fashion. That is, S1 will be enabled at time T−T1 for k data samples, then re-enabled at time (T−T1)+k, then at (T−T1)+2*k, and so on, until a match occurs, or until the n comparisons are completed.

The hash determination and comparison may be effected via hardware, as illustrated in FIG. 1, or software, or a combination of both. For example, the hash devices 120 of FIG. 1 may be embodied as multiple software function calls that effect the hash function and store the result in corresponding registers for subsequent comparison with a source hash value. The hash function itself may be embodied as a software algorithm, a hardware device, or a sequence of firmware steps in a programmable hardware device. Other embodiments and combinations will be evident to one of ordinary skill in the art.

FIG. 2 illustrates an example flow diagram of a parallel hashing system in accordance with this invention, wherein each of the blocks or sequence of blocks may be embodied in hardware, software, or a combination of both.

At 210, at a time corresponding to the beginning of the range of hash determinations (i.e. when S1 of FIG. 1 is first enabled), the system is initialized by clearing the variables used to contain the hash values and setting a data index, i, to zero. As each new data value is received, at 220, the data index i is incremented. In the example flow diagram of FIG. 2, each new data value is applied to each of the hash variables that are affected by this data value. At 230, the range of hash variables that are affected by the current data sample is determined, as variables Lower and Upper. That is, for example, in the example of FIG. 1, the first data sample, when S1 is first enabled, will only be applied to the first hashing device 120, because the other enable signals S2-Sn will not yet be enabled. In this example, both Lower and Upper will be set equal to one. Similarly, the second data sample, when S2 is first enabled, will be applied to both the first and second hashing devices 120, and the Lower and Upper variables will be set to one and two, respectively. The Min and Max functions assure that the Lower and Upper variables are constrained to correspond to 1 to N hash variables.

The loop 240-249 applies the current data value to each of the hash variables within the Lower and Upper bounds. At 245, the hashing function corresponding to the hashing function at the source system is applied to the particular hash variables H(r), where r is the index that sequences from the Lower to Upper bounds.

At least K data samples must be processed before the first hash variable H(1) can be compared to the source hash value Hsource. The decision block at 250 effects a loop back to 220 to receive the next data sample if fewer than K data samples have been received. Thereafter, at the end of each loop process 240-249, the Lower hash value H(Lower) will be completed, and this completed hash value H(Lower) is compared to the source value Hsource, at 260. If the completed hash value H(Lower) equals the source hash value Hsource, the process terminates with a “Match” result, at 265. If this completed hash value is the last hash variable (Lower=N), at 270, the process terminates with a “No Match” result, at 275; otherwise, the process loops back to receive the next data sample, at 220.

As noted above, if the number of data values used to compute the hash variable, K, is less than the search range N, fewer hash variables can be used. In this case, the index to the hash variable will employ a modulo(K) function to reuse the hash variables, and each completed hash variable will be cleared before looping back to receive the next data sample, after 270.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A hashing system that is configured to receive a sequence of data values and a source hash value, comprising:
a plurality of hash devices,
each hash device of the plurality of hash devices being configured to apply a hash function to a received data value of the sequence of data values when enabled, and
at least one comparator, operably coupled to the plurality of hash devices, that is configured to compare an output of each hash device to the source hash value, to facilitate a verification of the sequence of data values.

2. The hashing system of claim 1, wherein
each hash device is enabled sequentially.

3. The hashing system of claim 1, wherein
each hash function is enabled for a duration of K data samples, and
the plurality of hash devices corresponds to K hash devices.

4. A method of determining a correspondence between a sequence of received data values and a source, based on a source hash value that corresponds to a subset of source data values, the method comprising:
selectively enabling one or more bash elements upon the occurrence of each data value of the sequence of received data values,
hashing each data value with each enabled hash element to produce a determined hash value corresponding to each of the one or more hash elements, and
comparing each determined hash value to the source hash value to determine the correspondence between the sequence of received data values and the source.

5. The method of claim 4, wherein
selectively enabling the one or more hash elements includes sequentially enabling each of the one or more hash elements.

6. The method of claim 4, wherein
selectively enabling the one or more hash elements includes enabling each of the one or more hash elements for a duration corresponding to K data values, and
the one or more hash elements correspond to K hash elements.
